(19) United States
(12) Patent Application Publication
(10) Pub. No.: US 2025/0299393 A1
(43) Pub. Date: Sep. 25, 2025

(54) INFORMATION PROCESSING APPARATUS, DISPLAY CONTROL METHOD, STORAGE MEDIUM, AND SYSTEM

(71) Applicant: CASIO COMPUTER CO., LTD., Tokyo (JP)

(72) Inventor: Kota SAJI, Tokyo (JP)

(73) Assignee: CASIO COMPUTER CO., LTD., Tokyo (JP)

(21) Appl. No.: 19/086,319

(22) Filed: Mar. 21, 2025

(30) Foreign Application Priority Data
Mar. 22, 2024 (JP) 2024-046320

(51) Int. Cl. G06T 11/20; G06F 3/0482

(52) U.S. Cl. CPC G06T 11/206; G06F 3/0482

(57) ABSTRACT

An information processing apparatus including a processor cause a display to display information, wherein the processor: receives a user operation on the 3-dimensional graph by an operation unit in response to causing the display to display a 3-dimensional graph corresponding to a 3-variable function, and causes the display to display a solution target object specified based on 3-dimensional coordinates on the 3-dimensional graph designated through the user operation on the 3-dimensional graph in response to the user operation on the 3-dimensional graph, and causes the display to display a result of a solution for the solution target object.

### CROSS-REFERENCE TO RELATED APPLICATIONS

This application claims the priority and benefit of Japanese Patent Application No. 2024-046320 filed on Mar. 22, 2024. The entire specification, claims, and drawings of Japanese Patent Application No. 2024-046320 are incorporated herein by reference.

### BACKGROUND

### Technical Field

The disclosure of the present specification relates to an information processing apparatus, a display control method, a storage medium, and a system.

### Related Art

For example, JP 2008-171384 A discloses a graph function calculator that has a graph drawing function of drawing and displaying a 2-dimensional graph according to a function formula. JP 2008-171384 A also describes a function of solving and displaying feature points of a 2-dimensional graph.

### SUMMARY

According to one aspect of the present disclosure, an information processing apparatus includes: a processor cause a display to display information, wherein the processor: receives a user operation on the 3-dimensional graph by an operation unit in response to causing the display to display a 3-dimensional graph corresponding to a 3-variable function, and causes the display to display a solution target object specified based on 3-dimensional coordinates on the 3-dimensional graph designated through the user operation on the 3-dimensional graph in response to the user operation on the 3-dimensional graph, and causes the display to display a result of a solution for the solution target object.

### BRIEF DESCRIPTION OF THE DRAWINGS

FIG. 1 is a diagram illustrating an exemplary configuration of a system according to an embodiment;

FIG. 2 is a diagram illustrating an example of a screen displayed on a terminal according to the embodiment;

FIG. 3 is a diagram illustrating another example of the screen displayed on the terminal according to the embodiment;

FIG. 4 is a diagram illustrating still another example of the screen displayed on the terminal according to the embodiment;

FIG. 5 is an exemplary flowchart illustrating processing executed by a terminal according to the embodiment when a function is input;

FIG. 6 is a diagram illustrating still another example of the screen displayed on the terminal according to the embodiment;

FIG. 7 is an exemplary flowchart illustrating processing executed by the terminal according to the embodiment when a mouseover event is detected at a sample point;

FIG. 8 is a diagram illustrating still another example of the screen displayed on the terminal according to the embodiment;

FIG. 9 is an exemplary flowchart illustrating processing executed by the terminal according to the embodiment when a mouse click event is detected on the sample point;

FIG. 10 is a diagram illustrating still another example of a screen displayed on the terminal according to the embodiment;

FIG. 11 is an exemplary flowchart illustrating processing executed by the terminal according to the embodiment when a mouse down event is detected at the sample point;

FIG. 12 is an exemplary flowchart illustrating processing executed by the terminal according to the embodiment when a right click event is detected at a click point;

FIG. 13 is a diagram illustrating still another example of the screen displayed on the terminal according to the embodiment;

FIG. 14 is an exemplary flowchart illustrating processing executed by the terminal according to the embodiment when a context menu click event is detected at the click point;

FIG. 15 is a diagram illustrating still another example of the screen displayed on the terminal according to the embodiment;

FIG. 16 is an exemplary flowchart illustrating processing executed by the terminal according to the embodiment when a right click event is detected at an intersection line;

FIG. 17 is a diagram illustrating still another example of the screen displayed on the terminal according to the embodiment;

FIG. 18 is an exemplary flowchart illustrating processing executed by the terminal according to the embodiment when a context menu click event is detected at an intersection line; and

FIG. 19 is a diagram illustrating still another example of the screen displayed on the terminal according to the embodiment.

### DETAILED DESCRIPTION

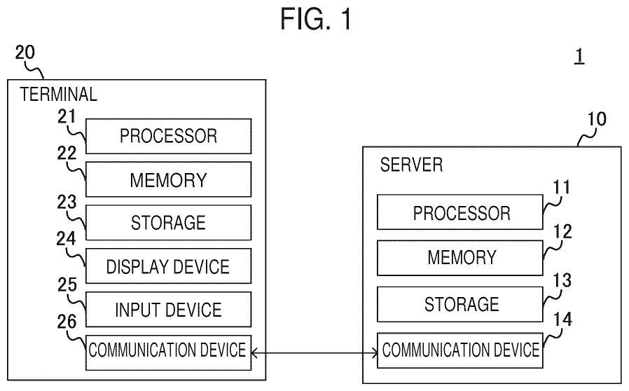

A system 1 illustrated in FIG. 1 includes a server 10 and a terminal 20 connected via a network such as the Internet. The server 10 is a computer that has a communication function and includes at least one processor 11, at least one memory 12 serving as a computer-readable non-transitory storage medium, a storage 13, and a communication device 14. The processor 11 includes, for example, a central processing unit (CPU). The processor 11 executes a program stored in the memory 12 or loaded from the storage 13 to the memory 12. The processor 11 may include any electric circuit such as a graphics processing unit (GPU), an application specific integrated circuit (ASIC), or a field-programmable gate array (FPGA). The memory 12 includes, for example, any semiconductor memory. The memory 12 may include a volatile memory such as a random access memory (RAM), and a nonvolatile memory such as a read only memory (ROM) or a flash memory. The storage 13 includes, for example, a magnetic storage device, an optical storage device, and other types of storage devices. The communication device 14 is, for example, a device including a communication circuit, and may be a device compatible with wireless communication such as Wi-Fi or BLE (Bluetooth Low Energy) or may be a device compatible with wired communication.

The terminal 20 is an information processing apparatus operated by a user who uses the system 1 and is a personal computer, a tablet terminal, a smartphone, an electronic dictionary terminal, a mobile phone, an electronic book terminal, a portable game machine, or the like. The terminal 20 is a computer that has a communication function and includes, for example, at least one processor 21, at least one memory 22 as a computer-readable non-transitory storage medium, a storage 23, a display device 24, an input device 25, and a communication device 26. The processor 21 includes, for example, a central processing unit (CPU). The processor 21 executes a program stored in the memory 22 or loaded from the storage 23 to the memory 22 and a program (script) received from the server 10, and thus operates as a controller that causes the display device 24 as a display to display various types of information. Like the processor 11, the processor 21 may also include any electrical circuit. The memory 22, the storage 23, and the communication device 26 are similar to the memory 12, the storage 13, and the communication device 14. The display device 24 is an example of a display and includes, for example, a liquid crystal display, an organic EL display, and a CRT display. The input device 25 includes a keyboard, a mouse, a touch device, and the like. The display device 24 and the input device 25 may be configured as, for example, a touch panel display or may be integrally configured. The display device 24 and the input device 25 may be provided in the same housing as the main body including the processor 21 or may be configured separately from the main body.

The system 1 that has the above configuration provides a user of the system 1 with a drawing function of drawing a 3-dimensional graph and a solving function for the 3-dimensional graph in response to a user operation through the terminal 20. Hereinafter, the terminal 20 mainly operates as a display control device that controls display information provided to the user, and the server 10 operates as an arithmetic device that executes various types of arithmetic processing related to solving of a 3-dimensional graph in response to a request from the terminal 20. However, a sharing role between the server 10 and the terminal 20 is not particularly limited to this example. For example, the terminal 20 alone may provide the user with both the function of drawing the 3-dimensional graph and the solving function for the 3-dimensional graph. The system 1 is, for example, a web application system. The user of the system 1 may access a web application operating on the server 10 via a web browser operating on the terminal 20 to use the drawing function and the solving function provided by the system 1. However, the system 1 is not limited to the web application system. The system 1 may provide the drawing function and the solving function to the user by exchanging a client application installed in the terminal 20 with a server application operating on the server 10. When the terminal 20 provides both the drawing function and the solving function, the server 10 may provide only a management function such as user management and data storage.

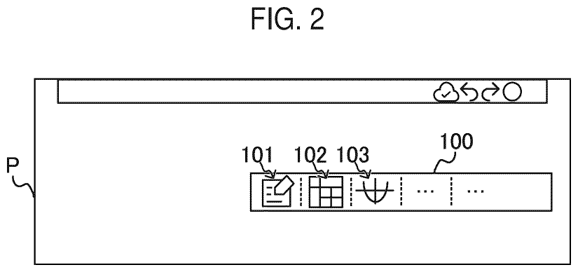

Hereinafter, when the system 1 is a web application system of an electronic notebook type computer (hereinafter simply referred to as a notebook) that records any information on the server 10, and provides the drawing function of drawing a 3-dimensional (3D) graph on the electronic notebook and the solving function for the 3D graph will be described as an example. First, when the user operates the terminal 20 to access a web application operating on the server 10, the notebook is opened on the web browser and displayed on the display device 24. Thereafter, when an operation of opening paper for using the drawing function of drawing a 3D graph on the notebook or the like is executed, the system 1 causes the display device 24 of the terminal 20 to display the paper P. The system 1 monitors the user operation on the paper P and executes processing in response to the detected operation. When a paper selection operation of selecting a portion where nothing is displayed on the paper P is detected, the system 1 causes the display device 24 to display a menu 100 on the paper P as illustrated in FIG. 2. The menu 100 includes a plurality of icons (icons 101, 102, 103, and the like). The icon 101 is used to give an instruction to generate a text tag. The icon 102 is used to give an instruction to generate a statistical data tag. The icon 103 is used to give an instruction to generate a graph tag. The tag is a display area in which the user can freely change a deployment in the paper P, and is information recorded on the server 10. The tag is also referred to as an electronic tag or a sticky.

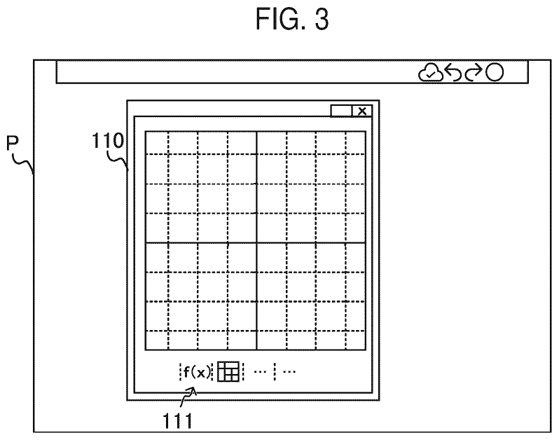

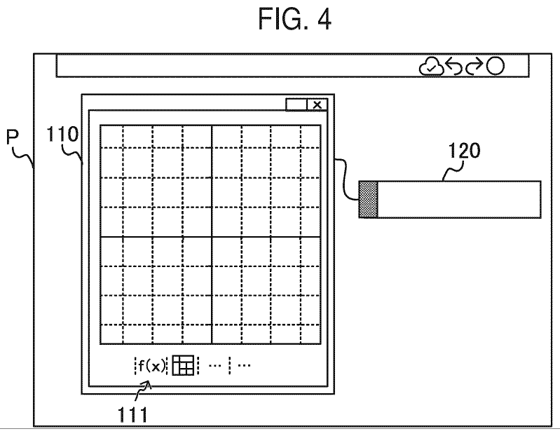

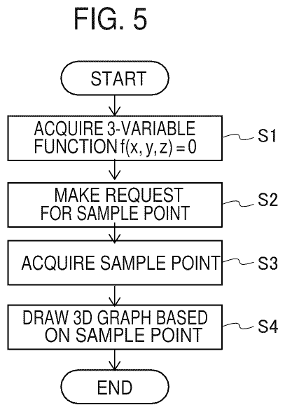

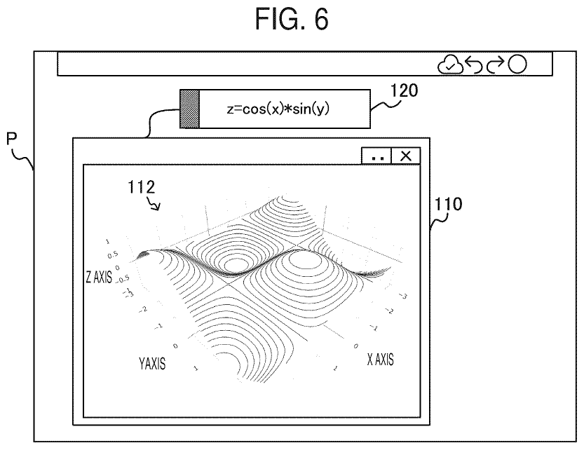

When an operation on the icon 103 (tag icon selection operation) is detected, the system 1 generates the graph tag 110 in response to an operation and displays the graph tag in the paper P on the display device 24. Thereafter, when an operation of selecting the graph tag 110 is detected, the system 1 causes the display device 24 to display a plurality of icons (an icon 111, and the like) in the graph tag 110 as illustrated in FIG. 3. The icon 111 is used to give an instruction to generate a graph tag. When an operation on the icon 111 (tag icon selection operation) is detected, the system 1 causes the display device 24 to display the graph tag 110 in association with a graph tag 120, as illustrated in FIG. 4. When the user inputs a formula of the 3-variable function to the graph tag 120, the processor 21 in the terminal 20 executes a program to execute processing illustrated in FIG. 5. Specifically, the processor 21 acquires the formula of the 3-variable function f(x, y, z)=0 input to the graph tag 120 (step S1), transmits the formula of the 3-variable function f(x, y, z)=0 acquired in step S1 to the server 10, and makes a request for the sample point of the 3-variable function f(x, y, z)=0 (step S2). The server 10 that has received the request specifies a plurality of sample points which are each a combination of values of three variables satisfying the function formula, and transmits a response including information regarding the plurality of specified sample points to the terminal 20. In the terminal 20 that has received the response, the processor 21 acquires the information regarding the sample points (step S3), draws the 3D graph based on the acquired information of the sample point (step S4), and displays the 3D graph corresponding to the 3-variable function on the display device 24. FIG. 6 illustrates a state in which a 3-variable function “z=cos (x)·sin (y)” is input to the graph tag 120, and the 3D graph 112 is displayed in the graph tag 110. As illustrated in FIG. 6, in step S4, the processor 21 causes the display device 24 to display the 3D graph 112 as a 2-dimensional image by mapping the sample points in a 2-dimensional space. That is, the 3D graph is formed by a set of the sample points corresponding to the 3-variable function, and is a 2-dimensional image when the sample points distributed in a 3-dimensional space are viewed in a specific direction (hereinafter referred to as a gaze direction). The gaze direction may be changeable through a user operation. For example, when the 3D graph 112 is selected and dragged, the processor 21 may rotate the 3D graph 112 to convert the gaze direction.

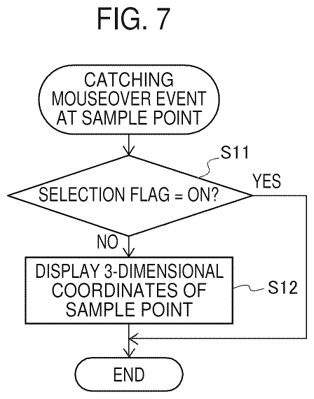

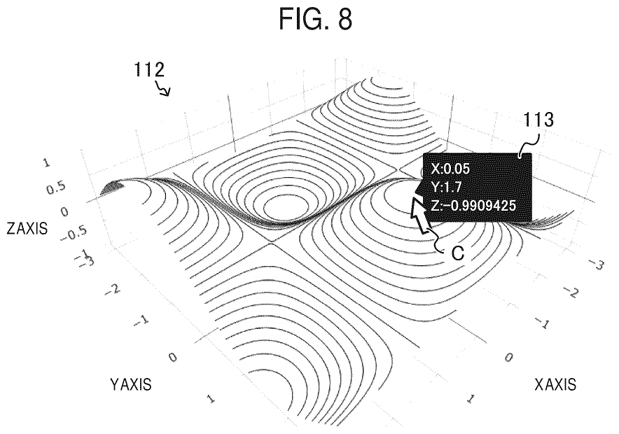

Thereafter, in response to various operations on the 3D graph 112 by the user, the terminal 20 displays a solution target object for which a solution is to be found for the 3-variable function specified based on the 3-dimensional coordinates on the 3D graph 112 designated through the user operation on the 3D graph 112 and displays a result of the solution for the solution target object on the display device 24. Specifically, an operation is executed as follows. For example, when the user moves a cursor C onto the 3D graph 112, a mouseover event occurs at the sample point at the location of cursor C. When the mouseover event at the sample point is detected, the processor 21 executes processing illustrated in FIG. 7. In the processing illustrated in FIG. 7, the processor 21 first determines whether a selection flag is turned ON (step S11). When the selection flag is not turned ON, the 3-dimensional coordinates of the sample point at the position of cursor C are displayed (step S12). FIG. 8 illustrates a state in which a balloon 113 is displayed at the sample point on which the cursor C is placed and X (=22.2), Y (=1.05), and Z (=−0.5104795) that are values of the three variables x, y, and z of the sample point in the balloon 113, that is, 3-dimensional coordinates, are displayed. When there is no sample point at the position of the cursor C, the balloon 113 may be displayed at a sample point close to the cursor C. When the selection flag is turned ON, the processor 21 ends the processing of the sample point illustrated in FIG. 7 without displaying the 3-dimensional coordinates. The selection flag will be described below.

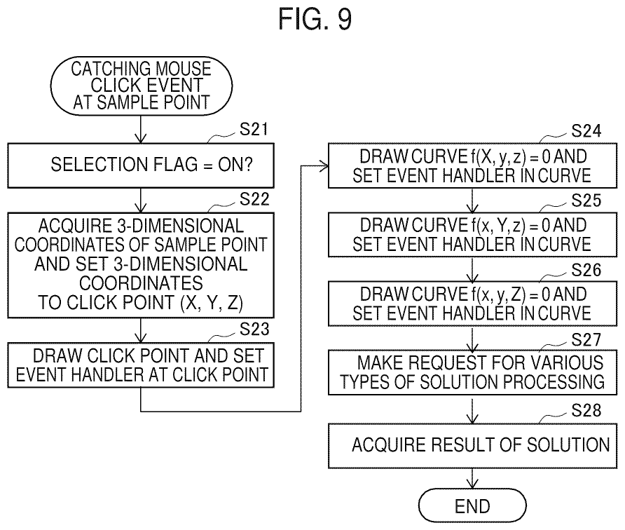

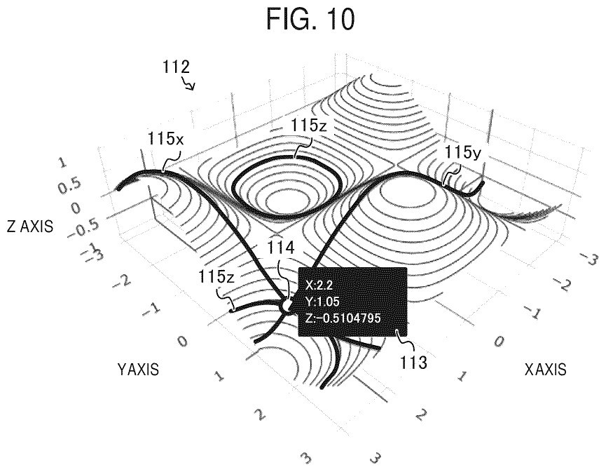

When the user executes a click operation at any position on the 3D graph 112, a mouse click event is generated at the sample point located at the position of the cursor C. The mouse click event is an example of an event generated through a user operation on the 3D graph 112. When the mouse click event at the sample point is detected, the processor 21 executes processing illustrated in FIG. 9 in response to the detection of the event. In the processing illustrated in FIG. 9, the processor 21 first sets the selection flag to ON (step S21), acquires the 3-dimensional coordinates of the sample point at which the event has been generated, and sets the 3-dimensional coordinates to the click point (X, Y, Z) (step S22). A click point 114 is an example of an object specified based on the 3-dimensional coordinates on the 3D graph 112 designated through a user operation such as a mouse click, and is an example of a solution target object for which a solution is to be found for the 3-variable function. Thereafter, the processor 21 draws the click point 114 on the 3D graph 112, and sets an event handler at the click point 114 (step S23). In step S23, the processor 21 first causes the display device 24 to display the click point 114 that is an object specified based on the 3-dimensional coordinates on the 3D graph 112 designated through the user operation on the 3D graph 112. The 3-dimensional coordinates on the 3D graph 112 designated through the user operation are specified with the values of the three variables corresponding to the sample points mapped to a position on the 2-dimensional image selected through the user operation. When a plurality of sample points are mapped to positions on the 2-dimensional image selected through the user operation, the processor 21 may specify the 3-dimensional coordinates on the 3D graph 112 designated through the user operation with values of three variables corresponding to the sample points selected by a predetermined rule from the plurality of sample points mapped on the position. The predetermined rule is not particularly limited. For example, a sample point on the frontmost side in a gaze direction of the 2-dimensional image may be selected among the plurality of sample points. FIG. 10 illustrates a state in which the click point 114 is drawn as a white circle. The processor 21 also dynamically sets an event handler at the drawn click point 114. Specifically, for the click point 114, the processor 21 sets an event handler that displays a context menu when an event generated during a right click at the click point 114 is detected, and sets an event handler that executes processing according to an item clicked when an event generated during clicking of an item in the context menu is detected. The items of the context menu include, for example, “tangent plane equation” for displaying a tangent plane equation, “label display” for displaying a label indicating 3-dimensional coordinates in a different display format, and “table conversion” for displaying 3-dimensional coordinates in a table format. Regardless of which item is selected, a result of a solution (for example, calculation of an equation, format conversion of coordinate values, or the like) for the click point 114 (sample point) is displayed. That is, the event handler that executes processing corresponding to the clicked item is an event handler that displays a result of the solution for the click point 114 (object).

The processor 21 further draws a curve f (X, y, z)=0 on the 3D graph 112 and sets an event handler in the curve f (X, y, z)=0 (step S24). In step S24, the processor 21 first causes the display device 24 to display the curve f (X, y, z)=0 derived by substituting X (in this example, 2.2) that is a variable value of x of the click point 114, into x of the 3-variable function on the 3D graph 112. Similarly to the click point 114, the curve f (X, y, z)=0 is an example of an object specified based on 3-dimensional coordinates on the 3D graph 112 designated through a user operation such as a mouse click and is an example of a solution target object for which a solution is to be found for the 3-variable function. The curve f (X, y, z)=0 is an object indicating a state in which a value of at least one variable among the three variables included in the 3-variable function is fixed to a value indicated by the 3-dimensional coordinates and is an example in which a line tangent to the 3-dimensional coordinates is set as the solution target object. FIG. 10 illustrates a state in which an intersection line 115x indicating the curve f (X, y, z)=0 is drawn on the 3D graph 112. Further, the processor 21 dynamically sets an event handler in the drawn intersection line 115x. Specifically, for the intersection line 115x, the processor 21 sets an event handler that displays a context menu when an event generated during a right click in the intersection line 115x is detected, and sets an event handler that executes processing according to a clicked item when an event generated during a click on an item of the context menu is detected. The items of the context menu include, for example, “2D graph” for displaying the intersection line in a 2D graph, “intersection line equation” for displaying an equation (function formula) of the intersection line, and “rotation around an axis” for displaying a rotating body formed by rotating the intersection line around an axis (the x axis, the y axis, or the z axis). Regardless of which item is selected, result display of a solution (for example, calculation of an equation or the like) for the intersection line 115x is executed. That is, the event handler that executes processing corresponding to the clicked item is the event handler that displays a result of the solution for the intersection line 115x (object).

The processor 21 further draws a curve f(x, Y, z)=0 on the 3D graph 112, sets an event handler for the curve f(x, Y, z)=0 (step S25), draws a curve f(x, y, Z)=0 on the 3D graph 112, and sets an event handler for the curve f(x, y, Z)=0 (step S26). The processing of steps S25 and S26 is similar to the processing of step S24 except that a variable value to be substituted is Y or Z instead of X. FIG. 10 illustrates a state in which an intersection line 115y indicating a curve f(x, Y, z)=0 and an intersection line 115z indicating a curve f(x, y, Z)=0 are drawn on the 3D graph 112. When the drawing of the object and the dynamic setting of the event handler for the object end, the processor 21 requests the server 10 to execute various types of solution processing in order to acquire in advance a solution result to be displayed when the event handler is executed (step S27). The server 10 that has received the request transmits, to the terminal 20, a response including a result of the solution obtained by executing various of solving processing. In the terminal 20 that has received the response, the processor 21 acquires the result of the solution and stores the result in the memory 22 (step S28). In this way, the processor 21 displays, on the 3-dimensional graph, a plurality of solution target objects (the click point 114, the intersection line 115x, the intersection line 115y, and the intersection line 115z) specified through a mouse click based on the 3-dimensional coordinates of a click point.

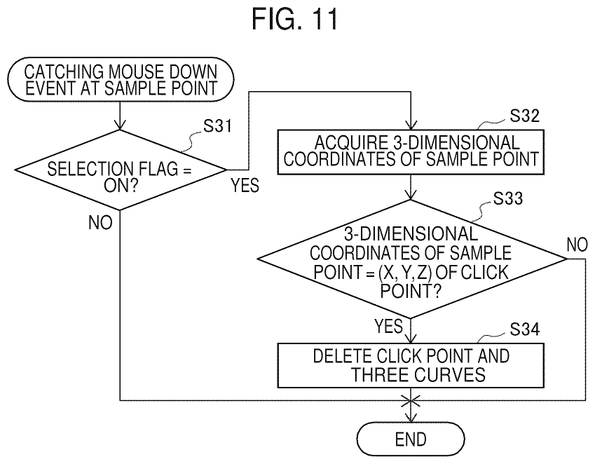

When the user executes a click operation at any position on the 3D graph 112, a mouse down event occurs before the mouse click event. When the mouse down event at the sample point is detected, the processor 21 executes the processing illustrated in FIG. 11 in response to the detection of the event. During a first mouse click on the sample point, the selection flag remains OFF (initial value) without executing the processing illustrated in FIG. 9 corresponding to the mouse click event. Therefore, the processor 21 determines that the selection flag is turned OFF (NO in step S31) and ends the processing illustrated in FIG. 11. Conversely, during a mouse click on the sample point for the second or subsequent time, the processing illustrated in FIG. 9 is executed at least once, and the selection flag is turned ON. Therefore, the processor 21 determines that the selection flag is turned ON (YES in step S31) and first acquires the 3-dimensional coordinates of the sample point (step S32). Thereafter, the processor 21 determines whether the acquired 3-dimensional coordinates of the sample point match the 3-dimensional coordinates (X, Y, Z) of the click point set by the previous click operation (step S33). When the 3-dimensional coordinates do not match each other, the processor 21 ends the processing illustrated in FIG. 11 without executing additional processing. When the 3-dimensional coordinates match each other, the processor deletes the click point and the three curves (three intersecting lines) displayed on the 3D graph 112 (step S34). Accordingly, the click point and the three curves drawn through the previous click operation are not displayed, and only a new click point and the three curves are drawn through a mouse click generated after the mouse down event.

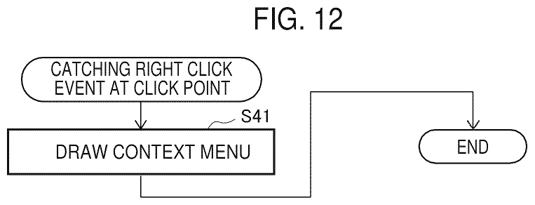

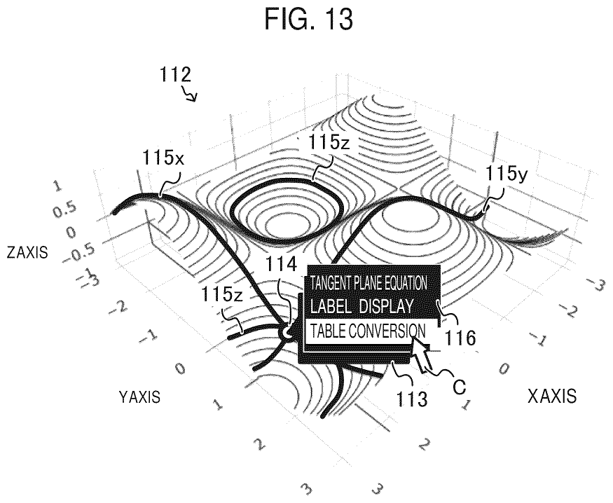

When the user selects the click point 114 and executes a right click operation with the click point 114 being displayed by a click operation at any position on the 3D graph 112, a right click event occurs. When the right click event for the click point 114 is detected, the processor 21 executes the event handler set in step S23 of FIG. 9 to execute the processing illustrated in FIG. 12, specifically, the processing for drawing the context menu (step S41). FIG. 13 illustrates a state in which the context menu 116 is displayed near the click point 114 in response to the right click on the click point 114. The context menu 116 includes items “tangent plane equation”, “label display”, and “table conversion” as options.

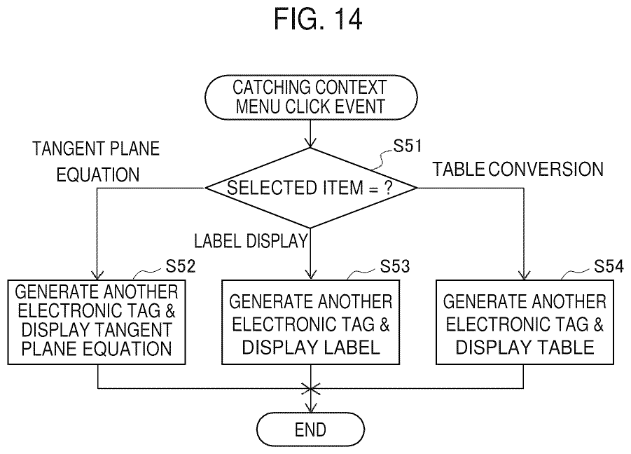

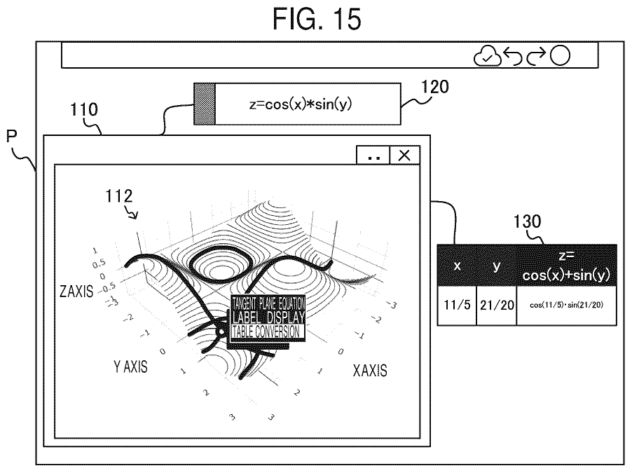

When the user selects an item of the context menu 116 and executes a click operation with the context menu 116 being displayed, a click event occurs. When the click event for the context menu 116 of the click point 114 is detected, the processor 21 executes the processing illustrated in FIG. 14 by executing the event handler set in step S23 of FIG. 9 in response to the detection of the event. Specifically, the processor 21 first determines a selected item (step S51). When the selected item is “tangent plane equation”, the processor 21 generates a tag different from the graph tag 110 in which the 3D graph 112 is drawn and newly displays a function equation of the tangent plane equation in the tag (step S52). The function equation of the tangent plane equation is read from information acquired in advance in step S28 of FIG. 9 and stored in the memory 22. When the selected item is “label display”, the processor 21 generates a tag different from the graph tag 110 and newly displays 3-dimensional coordinates corresponding to the click point in the tag in a format different from the format displayed in the balloon 113 (step S53). The 3-dimensional coordinates in a different format are read from the information acquired in advance in step S28 in FIG. 9 and stored in the memory 22. Here, the 3-dimensional coordinates displayed in the balloon 113 are in a decimal format, and the 3-dimensional coordinates in different forms are in the fraction format. When the selected item is “table conversion”, the processor 21 generates a tag different from the graph tag 110 and displays 3-dimensional coordinates corresponding to the click point in the table newly generated in the tag (step S54). FIG. 15 illustrates a state in which a table tag 130 different from the graph tag 110 is displayed in response to a click of “table conversion”. The graph tag 110 is an example of a first electronic tag, and the table tag 130 is an example of a second electronic tag. Here, an example is illustrated in which the 3-dimensional coordinates (coordinate values of x, y, and z of 2.2 and 1.05, and z=cos (11/5)·sin (21/20)) in the table tag 130 are displayed in a fraction format. When the table tag has already been generated, 3-dimensional coordinates may be added to the generated table tag. The 3-dimensional coordinates of the plurality of points may be added to one table tag by repeating a click operation and table conversion on the 3-dimensional graph. The processing from steps S52 to S54 described above is an example of the processing in which the processor 21 causes the display device 24 to display a result of a solution for the click point 114 in response to the detection of the event generated through the user operation on the click point 114, and is an example in which a result of the solution for the click point 114, which is a solution target object designated according to a user operation among the plurality of solution target objects displayed on the 3D graph 112, is displayed on the display device 24. More specifically, the processing is an example in which the display device 24 is caused to display a result obtained by executing a solving function designated in accordance with a user operation among a plurality of solving functions (a tangent plane equation, label display, table conversion, and the like) for click point 114, which is a solution target object designated in response to the user operation.

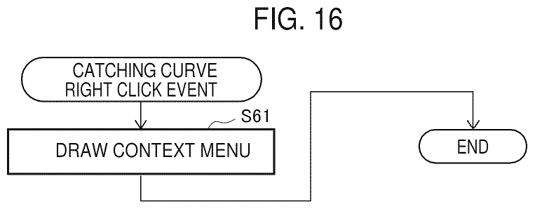

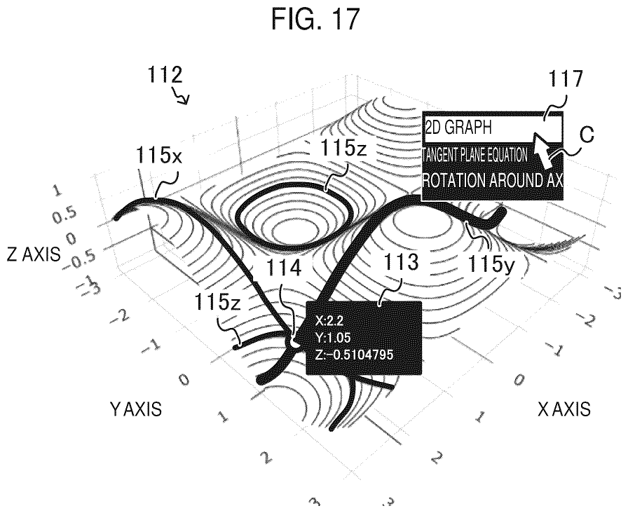

When the user selects an intersection line and executes a right click operation in a state where the intersection line with the click point 114 is displayed through a click operation at any position on the 3D graph 112, a right click event occurs. When the right click event on the intersection line is detected, the processor 21 executes the event handler set in step S24 to step S26 of FIG. 9 to execute the processing illustrated in FIG. 16, specifically, the processing for drawing the context menu (step S61). FIG. 17 illustrates a state in which the context menu 117 is displayed in the vicinity of the intersection line 115y in response to the right click on the intersection line 115y. The context menu 117 includes items “2D graph”, “intersection line equation”, and “rotation around axis” as options. The options may further include “table conversion”. In this way, the plurality of solving functions that can be executed on the solution target object may be at least partially different for each type (for example, a click point, an intersection line, and the like) of the solution target object. Hereinafter, the processing on the intersection line 115y will be described. The same applies to processing on the intersection line 115x and the intersection line 115z.

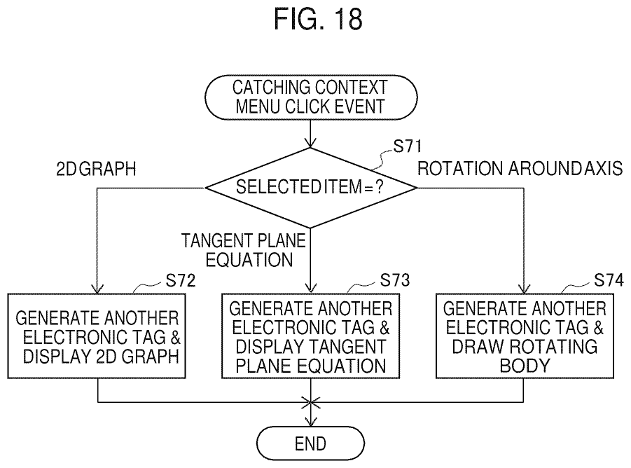

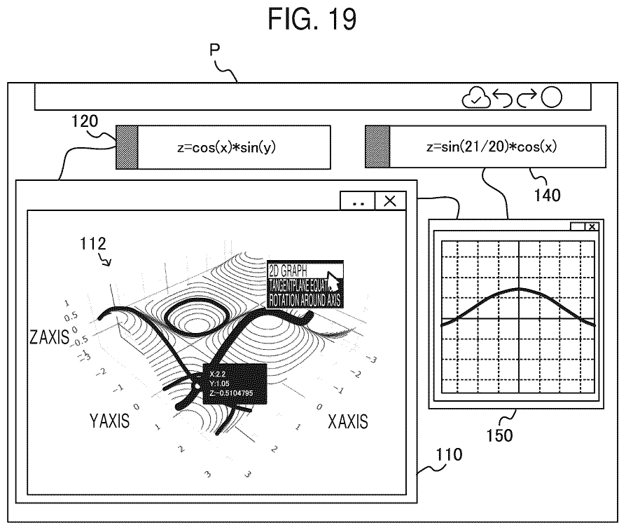

When the user selects an item of the context menu 117 and executes a click operation with the context menu 117 being displayed, a click event occurs. When the click event on the context menu 117 of the intersection line 115y is detected, the processor 21 executes the processing illustrated in FIG. 18 by executing the event handler set in step S25 of FIG. 9 in response to the detection of the event. Specifically, the processor 21 first determines a selected item (step S71). When the selected item is “2D graph”, the processor 21 generates a tag different from the graph tag 110 on which the 3D graph 112 is drawn, and newly draws a 2D graph of the intersection line 115y in the tag (step S72). The information necessary for drawing the 2D graph is acquired in advance in step S28 of FIG. 9 and is read from the information stored in the memory 22. When the selected item is “intersection line equation”, the processor 21 generates a tag different from the graph tag 110 and newly displays a function equation of an intersection line equation of the 3-variable function and a plane determined with a Y coordinate (Y=1.05) of the click point 114 in the tag (step S73). The function equation of the intersection line equation is read from the information acquired in advance in step S28 of FIG. 9 and stored in the memory 22. When the selected item is “rotation around axis”, the processor 21 generates a tag different from the graph tag 110 and newly draws a rotating body generated by rotating the intersection line 115y in the tag by 360 degrees around any of the x, y, and z axes as a central axis (step S74). A user may be further allowed to select which axis of the rotating body is displayed. The information necessary for drawing the rotating body is acquired in advance in step S28 of FIG. 9 and is read from the information stored in the memory 22. When “table conversion” is included in the context menu 117 and “table conversion” is selected, a table tag including a plurality of coordinate values corresponding to the intersection line may be generated. FIG. 19 illustrates a state after a click of each of “intersection line equation” and “2D graph” from the context menu 117. FIG. 19 illustrates a state in which the graph tag 140 and the graph tag 150 different from the graph tag 110 are displayed. Here, the example in which the graph tag 140 is associated with the graph tag 150 has been described, but the graph tag 140 may be associated with the graph tag 110. The processing from steps S72 to S74 described above is an example of the processing in which the processor 21 causes the display device 24 to display a result of the solution for the intersection line 115y in response to the detection of the event occurring through a user operation on the intersection line 115y, and is an example in which the display device 24 is caused to display a result obtained by executing the solving function selected in accordance with the user operation from the selection menu including options of the solving functions corresponding to the type of solution target object designated in accordance with the user operation among the plurality of solving functions.

According to the system 1, the terminal 20 can provide a function of drawing a 3D graph and a solving function for an object on the 3D graph. In particular, an object is displayed on the 3D graph through a user operation on the 3D graph, and a result of the solution for the object is displayed by a further user operation on the object. The object may be a point (for example, a sample point) or a line (for example, an intersection line) as described above. The object may be a plane (for example, a tangential plane). That is, the object may be any spatial figure (including points, lines, and planes) displayed on the 3D graph. That is, it is possible to obtain a result of a solution for an object freely selected by a user operating a 3D graph, and the user can further understand the 3-variable function visualized as a 3D graph through an intuitive user operation.

The 3D graph for visualizing the 3-variable function is displayed as a 2-dimensional image, but 3-dimensional information can be maintained by generating a 3D graph as a set of sample points. Accordingly, it is possible to restore the 3-dimensional information from the position on the 2-dimensional image specified through the user operation on the 3D graph visualized as the 2-dimensional image, and it is possible to display the object and display the result of the solution for the object using the 3-dimensional information. Even when a plurality of sample points are mapped to positions on the 2-dimensional image, it is possible to select an appropriate object, and obtain and display the result of the solution by specifying the sample points by the predetermined rule. For example, predictability of an object (for example, a sample point) to be selected is increased by setting a rule that the front side in the gaze direction is preferentially selected, and an object located on the back side in the gaze direction can be selected through an additional operation (for example, an additional click operation).

By dynamically setting the event handler in an object to be newly displayed in response to the user operation on the 3D graph, it is possible to set the event handler in a necessary object without excess or deficiency. Accordingly, since a situation in which an event handler of an unintended object is executed can be avoided, it is possible to realize high operability. By displaying various types of information (the 3D graph and the result of the solution) in the electronic tag generated in the paper P, the types of information can be freely moved in the screen. In addition, by displaying the 3D graph and the solution result in separate electronic tags, it is possible to prevent information from being excessively concentrated on one electronic tag. Accordingly, it is easy to ascertain information and to execute a management operation such as addition or deletion of the upper side.

The above-described embodiments have been given as specific examples to facilitate understanding of the present disclosure, and the present disclosure is not limited to the above-described embodiments, and should be understood as including various modifications and alternative embodiments of the above-described embodiments. For example, it will be understood that the above-described embodiments can be realized by modifying components without departing from the gist of the present disclosure. It will be understood that various embodiments can be implemented by appropriately combining a plurality of components disclosed in the above-described embodiments. Further, those skilled in the art may understand that various embodiments may be implemented by deleting some components from all the components shown in the embodiments or adding some components to the components shown in the embodiments.

In the above-described embodiment, the case where the user operation is an operation using a mouse has been described as an example, but the user operation is not limited to a mouse operation. For example, when the terminal 20 includes a touch panel display such as a tablet type terminal, the user operation may be any of various operations on the touch panel. In the above-described embodiment, the example in which the 3D graph and the result of solution for the object on the 3D graph are displayed in the electronic tag has been described, but a location at which the 3D graph and the result of the solution are displayed is not limited to the electronic tag. The function may be provided not only in an application related to the electronic tag but also in any application. In the above-described embodiment, the example in which a line tangent to the 3-dimensional coordinates of a click point is displayed on the 3D graph as a solution target object has been described. However, a plane tangent to the 3-dimensional coordinates of the click point (for example, a tangential plane) may be displayed on the 3D graph as a solution target object.

What is claimed is:

1. An information processing apparatus comprising a processor cause a display to display information, wherein
the processor:
receives a user operation on the 3-dimensional graph by an operation unit in response to causing the display to display a 3-dimensional graph corresponding to a 3-variable function, and
causes the display to display a solution target object specified based on 3-dimensional coordinates on the 3-dimensional graph designated through the user operation on the 3-dimensional graph in response to the user operation on the 3-dimensional graph, and causes the display to display a result of a solution for the solution target object.

2. The information processing apparatus according to claim 1, wherein
the processor causes an object indicating a state in which a value of at least one variable among three variables included in the 3-variable function is fixed to values indicated by the 3-dimensional coordinates to be displayed on the 3-dimensional graph as the solution target object.

3. The information processing apparatus according to claim 1, wherein
the processor causes a line or a plane tangent to the 3-dimensional coordinates to be displayed on the 3-dimensional graph as the solution target object.

4. The information processing apparatus according to claim 1, wherein
the processor:
causes a plurality of the solution target objects specified based on the 3-dimensional coordinates to be displayed on the 3-dimensional graph, and
causes to the operation unit to receive a designation through a user operation on one solution target object among the plurality of solution target objects displayed on the 3-dimensional graph, and causes the display to display a result of the solution for the solution target object designated through the user operation.

5. The information processing apparatus according to claim 4, wherein
the processor causes the display to display a result obtained by executing a solving function designated through a user operation among a plurality of solving functions for the solution target object designated through the user operation.

6. The information processing apparatus according to claim 5, wherein
at least some of the plurality of solving functions executable for the solution target object are different for each type of solution target object, and
the processor:
causes the display to display a selection menu including options of the solving function corresponding to the type of solution target object designated through the user operation among the plurality of solving functions,
causes the operation unit to receive a selection on the selection menu, and
causes the display to display a result obtained by executing the solving function selected from the selection menu through a user operation.

7. The information processing apparatus according to claim 1, wherein
the 3-dimensional graph is formed by a set of sample points corresponding to the 3-variable function,
the processor:
causes the display to display the 3-dimensional graph as a 2-dimensional image by mapping the sample points in a 2-dimensional space, and
specifies 3-dimensional coordinates on the 3-dimensional graph designated through the user operation with values of three variables corresponding to the sample points mapped to positions on the 2-dimensional image selected through the user operation.

8. The information processing apparatus according to claim 1, wherein
the processor:
dynamically sets an event handler displaying a result of a solution for the solution target object in the solution target object in response to detection of an event occurring through a user operation on the 3-dimensional graph, and
executes the event handler in response to the detection of the event occurring through the user operation on the solution target object.

9. The information processing apparatus according to claim 1, wherein
the processor:
causes the display to display the 3-dimensional graph and the solution target object in a first electronic tag, and
causes the display to display a result of the solution in a second electronic tag different from the first electronic tag.

10. An information processing method causing a computer of an information processing apparatus to execute:
causing a display to display a 3-dimensional graph corresponding to a 3-variable function; and
causing the display to display a solution target object, which is a solution target object specified based on 3-dimensional coordinates on the 3-dimensional graph designated through a user operation and is a solution target object for which a solution is to be found for the 3-variable function, on the 3-dimensional graph in response to a user operation on the 3-dimensional graph and causing the display to display a result of the solution for the solution target object.

11. The information processing method according to claim 10, causing the computer to further execute:
displaying a plurality of the solution target objects specified based on the 3-dimensional coordinates on the 3-dimensional graph; and
causing an operation unit to receive a designation through a user operation on one solution target object among the plurality of solution target objects displayed on the 3-dimensional graph, and causing the display to display the result of the solution for the solution target object designated through the user operation.

12. The information processing method according to claim 11, causing the computer to further execute:
causing the display to display a result obtained by executing a solving function designated in response to a user operation among a plurality of solving functions for the solution target object designated through the user operation; and
causing the display to display a selection menu formed by options of the solving function corresponding to a type of solution target object designated through the user operation among the plurality of solving functions, causing the operation unit to receive a selection from the selection menu, and causing the display to display a result obtained by executing the solving function selected from the selection menu through a user operation, wherein
at least some of the plurality of solving functions executable for the solution target object are different for each type of solution target object.

13. The information processing method according to claim 10, causing the computer to further execute:
dynamically setting an event handler displaying the result of the solution for the solution target object in the solution target object in response to detection of an event occurring through a user operation on the 3-dimensional graph; and
executing the event handler in response to the detection of the event occurring through the user operation on the solution target object.

14. The information processing method according to claim 10, causing the computer to further execute:
causing the display to display the 3-dimensional graph and the solution target object in a first electronic tag; and
causing the display to display the result of the solution in a second electronic tag different from the first electronic tag.

15. A non-transitory computer-readable storage medium storing a program causing a computer of an information processing apparatus to execute:
causing a display to display a 3-dimensional graph corresponding to a 3-variable function; and
causing the display to display a solution target object, which is a solution target object specified based on 3-dimensional coordinates on the 3-dimensional graph designated through a user operation and is a solution target object for which a solution is to be found for the 3-variable function, on the 3-dimensional graph in response to a user operation on the 3-dimensional graph and causing the display to display a result of the solution for the solution target object.

16. The storage medium according to claim 15, the program causing the computer to further execute:
displaying a plurality of the solution target objects specified based on the 3-dimensional coordinates on the 3-dimensional graph; and
causing an operation unit to receive a designation through a user operation on one solution target object among the plurality of solution target objects displayed on the 3-dimensional graph, and causing the display to display the result of the solution for the solution target object designated through the user operation.

17. The storage medium according to claim 16, the program causing the computer to further execute:
causing the display to display a result obtained by executing a solving function designated in response to a user operation among a plurality of solving functions for the solution target object designated through the user operation; and
causing the display to display a selection menu formed by options of the solving function corresponding to a type of solution target object designated through the user operation among the plurality of solving functions, causing the operation unit to receive a selection from the selection menu, and causing the display to display a result obtained by executing the solving function selected from the selection menu through a user operation, wherein
at least some of the plurality of solving functions executable for the solution target object are different for each type of solution target object.

18. The storage medium according to claim 15, the program causing the computer to further execute:
dynamically setting an event handler displaying the result of the solution for the solution target object in the solution target object in response to detection of an event occurring through a user operation on the 3-dimensional graph; and
executing the event handler in response to the detection of the event occurring through the user operation on the solution target object.

19. The storage medium according to claim 15, the program causing the computer to further execute:
causing the display to display the 3-dimensional graph and the solution target object in a first electronic tag; and
causing the display to display the result of the solution in a second electronic tag different from the first electronic tag.

20. A system comprising:
a server including a first processor; and
an information processing apparatus including a second processor, wherein
the second processor:
receives a user operation on the 3-dimensional graph by an operation unit in response to causing a display to display a 3-dimensional graph corresponding to a 3-variable function, and
causes the display to display a solution target object specified based on 3-dimensional coordinates on the 3-dimensional graph designated through the user operation on the 3-dimensional graph, and transmits information on the 3-dimensional coordinates to the server,
the first processor:
derives a solution of the 3-dimensional coordinates acquired by the information processing apparatus, and
transmits solution display information for displaying the derived solution to the information processing apparatus, and
the second processor causes the display to display the solution based on the solution display information as a result of a solution for the solution target object.
